(19) United States
(12) Patent Application Publication
(10) Pub. No.: US 2012/0045258 A1
(43) Pub. Date: Feb. 23, 2012

(54) Preheating of Marking Material-Substrate Interface for Printing and the Like

(75) Inventors: David K. Biegelsen, Portola Valley, CA (US); Ashish Pattekar, San Mateo, CA (US)

(73) Assignee: PALO ALTO RESEARCH CENTER INCORPORATED, Palo Alto, CA (US)

(21) Appl. No.: 12/861,750

(22) Filed: Aug. 23, 2010

(51) Int. Cl. G03G 15/16

(52) U.S. Cl. 399/307

(57) ABSTRACT

Substrate (or marking material) pre-heating is employed to facilitate fusing of the marking material with the substrate and with adjacent marking material. By heating primarily the material which becomes the interface between substrate and marking material, and by minimizing the distance between the point of heat application to the substrate (or marking material) and the marking nip in a print system, the amount of time for heat energy to dissipate prior to the application of the marking material to the substrate surface is minimized, meaning that the total amount of energy required to drive the heat source can be reduced. Addressable heating may be employed to further reduce energy consumption. Furthermore, optical heating may be used to provide rapid, on-demand heating, thereby reducing warm-up time as well as reducing unutilized heat energy.

### BACKGROUND

The present disclosure is related to transfer lamination methods (such as printing) and systems therefor, and more specifically to the pre-heating of the interface at which an imaging material, such as a toner, is applied to a substrate, such as paper.

Transfer lamination systems use one of a variety of devices to apply a marking material onto a substrate. One well-known example is an electrophotographic device, used for example for printing, copying, facsimile, etc. In such devices, a photosensitive drum or web is exposed by light to form a latent image thereon. The image is developed, typically with toner. The toner is transferred to a substrate such as paper, where by way of heat and pressure the toner is fused to the substrate, thereby creating a permanent image from the latent/developed image.

In a typical fusing stage of an electrophotographic device, two rollers are in contact with one another at a desired pressure, thereby forming a nip along the line of contact between the rollers. One or both rollers are heated, for example by an electrical element forming a part of the roller sleeve or core. Therefore, such systems are referred to as hot pressure fusers (HPF). In one variation, a web or belt replaces one of the rollers, and either the roller or belt or both are heated. The area of contact between the roller and the belt forms the nip. In either case, when a toner-bearing substrate (with a developed image) passes through the nip, the heat and pressure causes the toner to soften or melt, and thereby fuse with the substrate and adjacent toner particles.

However, hot pressure fusers are typically a significant, if not the major consumer of the overall energy budget of an electrophotographic device. In addition, a typical hot pressure fuser is relatively slow to heat to operating temperature, and is therefore a major contributor to the time required for an electrophotographic device to warm up to operating conditions.

In order to reduce energy consumption and operational wait-time, alternatives to HPF are being investigated. Such alternatives include cold pressure fusing (CPF) and warm pressure fusing (WPF). As their names suggest, these alternatives attempt to fuse toner at ambient and slightly-above ambient temperature, respectively. To accomplish this, special toners have been developed which fuse at relatively low temperatures. However, while fusing of toner particles has been demonstrated at low temperatures, a significant problem encountered with both CPF and WPF is the poor fix of the toner to the substrate. It is speculated that one reason for this is low flow of toner into the interstices (e.g., pores between fibers or coating material) of the substrate surface, which in turn results in poor mechanical adhesion.

It is known that in place of heating the substrate with the toner already applied, the blank substrate may be heated prior to application of the toner. This is useful in multi-pass systems and systems that use a photosensitive web and a pressure transfer nip. However, such substrate pre-heating systems still use two rollers, or one roller and a belt, with an electric heating element as part of the roller(s), belt or both. As used herein, the term pre-heating refers to heating an element of the system, such as substrate, marking material, etc., prior to the application of the marking material to the substrate.

It is also known that the toner itself may be preheated prior to fusing. This is accomplished either by drawing the toner from a heated pool or applying the toner to a heated transfer web or drum. However, in these methods either the toner is bulk heated without regard to heating one surface or another of the toner, or the toner is heated from a side opposite of that which ultimately contacts the substrate.

There has been inadequate attention paid in the art to selective placement of a device to heat one or both elements of the interface of marking material and substrate in order to minimize the energy consumed in heating the interface for fixing before pressure fusing. Still further, there has been inadequate investigation into types of heat sources and heat transfer members that minimize the energy consumed in heating the interface between the marking material and substrate for fixing before pressure fusing. Finally, there is a need to provide a faster heating cycle of the marking material and/or substrate to address the device warm-up time issues discussed above.

### SUMMARY

Accordingly, the present disclosure is directed to systems and methods for providing efficient, low energy consumption for the fixing or fusing of marking material to a substrate, for a transfer lamination system, for example in an electrophotographic marking system. The present disclosure is also directed to systems and methods for providing rapid warm-up times in an electrophotographic marking system, particularly in regard to the fixing of marking material to a substrate.

According to one aspect of the disclosure a heat transfer member such as a cylinder is provided with a heat source that imparts heat energy to a portion of the substrate, the marking material, or both, by absorption, conduction, convection, etc. where the substrate and marking material come into contact with one another—i.e., the marking material-substrate interface. As used herein, “absorption” is intended to mean absorption of radiation, such as absorption of light energy. In one embodiment, the heat source is a resistive heater. In other embodiments, the heat source may be another electrical, electromechanical, radiant (e.g., filament, laser, etc.) or electrochemical heat source. The heat transfer member is proximate or in physical contact with a substrate that is to receive and have fused thereon a marking material. The energy driving the heat source, and hence the amount of heat produced by the heat source, is controlled such that only the minimum amount of heat energy is transferred to the substrate to permit toner fusing into the substrate. Typically, this means that the point at which the heat transfer member imparts heat to the substrate is in close physical proximity to the nip at which the marking material is applied to the substrate. While different systems into which the present disclosure is integrated will define different degrees of closeness between the point of heat transfer and the nip, the concept of the present disclosure and the use of the term close physical proximity is meant to encompass the purposeful design of the system elements and operation of the system to minimize the distance between point of heat transfer and nip yet still provide effective pre-heating.

The minimized distance between point of heat transfer and nip means there is a minimized time for heat dissipation. That is, the amount of heat energy required to pre-heat the substrate is minimized. Furthermore, this typically means that only a portion of the thickness of the substrate is heated, preferably a portion extending from the surface at which the marking material is to be applied partway, but not all of the way, to the opposite surface, again further minimizing the needed heat energy for effective substrate pre-heating.

According to another aspect of the disclosure, in place of a resistive heater the heat source is an optical source, such as a light emitting diode (LED) bar or array, solid-state laser bar or array, and so forth. It will be understood here that “optical” is intended to mean any electromagnetic source of any output wavelength, whether visible to the unaided human eye or not (e.g., visible, infrared, etc.) In this case, the cylindrical heat transfer member may include a heat absorption layer of a material selected to be highly optically absorptive at the wavelengths of light emitted by the optical source. The optical source may be disposed within a transparent cylinder having an absorptive coating applied thereto. The optical source illuminates the absorptive coating through the transparent cylinder. Alternatively, the optical source may be disposed proximate and outside of the cylinder such that the optical source directly illuminates the absorptive coating. One advantage of the optical source is the ability to selectively heat portions of the heat transfer member (and ultimately the substrate), reducing the energy consumed in pre-heating the substrate (i.e., saving the energy that would go towards heating portions of the substrate that do not receive marking material). Another advantage of the optical source is the ability to rapidly heat the desired portions of the heat transfer member, thus reducing device warm-up time.

According to yet another aspect of the disclosure, the heat transfer member is a web or belt provided with a heat source. Again, the heat source may be by absorption, conduction, convection, etc., and may comprise a resistive heater or other electrical, electromechanical or electrochemical heater, or may be an optical source. One advantage provided by this aspect of the disclosure is that the belt remains in contact with the substrate for a longer period of time, thereby providing a more effective heat transfer from heat transfer member to substrate.

According to still another aspect of the disclosure, in place of pre-heating the substrate, the marking material is pre-heated. Typically, this may be accomplished by directing heat energy from a heat source to a region of the drum, web or plate carrying marking material to be deposited onto the substrate. The heat source again may be a resistive heater or other electrical, electromechanical or electrochemical heater or may be an optical source. The energy driving the heat source, and hence the amount of heat produced by the heat source, is controlled such that only the minimum amount of heat energy is transferred to the substrate to permit the marking material to fuse into the substrate and with any adjacent marking material. Typically, this means that the point at which the heat transfer member imparts heat to the marking material is physically close to the nip at which the marking material is applied to the substrate. Furthermore, this typically means that only a portion of the thickness of the marking material pile on the drum, web or plate is heated, preferably a portion extending from the surface of the marking material which is applied to the substrate partway, but not all of the way, to the opposite surface in contact with the drum, web, plate, etc. Of course both the substrate and the marking material may be pre-heated by the arrangements described above as well.

According to a still further aspect of the disclosure the heat transfer member is neither a roller nor web, but rather a member sized and shaped to be placed very close to the point at which marking material is applied to the substrate. The precise cross-sectional shape of this member will vary from application to application, but one example is a member with a roughly triangular cross-section for fitting closely in the wedge-shaped region between the pressure drum on the marking material side of the substrate and the substrate surface receiving the marking material. According to this aspect, the heat transfer member may employ a heat source comprising a resistive heater or other electrical, electromechanical or electrochemical heater. Alternatively, the heat source may be an optical source directed through an appropriately shaped mirror or lens, such as a prism, such that the optical energy is applied very close to the point at which the marking material is applied to the substrate. The heat source may heat the substrate, the marking material, or both. An advantage of this aspect of the disclosure is that the amount of time for heat energy to dissipate prior to the application of the marking material to the substrate surface is minimized, meaning that the total amount of energy required to drive the heat source can be kept to a minimum.

In each of the above described aspects, the amount of energy driving the heat source, and hence the amount of heat energy produced by the heat source, is limited to that amount needed to provide effective fixing of the marking material to the substrate. The actual amount of energy required will depend on many factors, such as the marking material, substrate, the pressure applied at the nip, the operating environment temperature, humidity, and pressure, the speed of travel of the substrate through the system, etc. However, by locating the pre-heating member(s) physically close to the point at which the marking material is applied to the substrate, energy consumed for heating the substrate and/or marking material to assist with fixing can be minimized. Furthermore, in applications that benefit from reduced warm-up time, selection of the proper heat source, such as an optical source, can provide both minimized energy usage and reduced warm-up time. Following the fixing of the material to the substrate other means, such as application of pressure across the marking material and substrate, can be used to complete the fusing of the marking material. The result is a marking material layer which is fused well and fixed well to the substrate.

The above is a summary of a number of the unique aspects, features, and advantages of the present disclosure. However, this summary is not exhaustive. Thus, these and other aspects, features, and advantages of the present disclosure will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is a side view of a first embodiment of a portion of an electrophotographic printing system including a substrate pre-heating heat transfer member according to the present disclosure.

FIG. 2 is another side view of the embodiment of the portion of an electrophotographic printing system including a substrate pre-heating heat transfer member shown in FIG. 1, illustrating heat transfer to the substrate.

FIG. 3 is a side view of another embodiment of a portion of an electrophotographic printing system including a substrate pre-heating heat transfer member according to the present disclosure, illustrating heat transfer to both the substrate and marking material prior to application of the marking material to the substrate.

FIG. 4 is a side view of another embodiment of a portion of an electrophotographic printing system including an optical heating mechanism according to the present disclosure, which also illustrates heat transfer to the substrate.

FIGS. 5A and 5B are cut-away perspective views of a roller heat transfer member with internally disposed optical heating mechanisms which are operated together and operated independently, respectively.

FIG. 6 is a side view of yet another embodiment of a portion of an electrophotographic printing system including a belt-type substrate pre-heating heat transfer member according to the present disclosure.

FIG. 7 is a side view of still another embodiment of a portion of an electrophotographic printing system including a marking material-specific pre-heating arrangement according to the present disclosure.

FIG. 8 is a side view of a still further embodiment of a portion of an electrophotographic printing system including a substrate pre-heating heat transfer member shaped and disposed for minimal spacing from the marking nip according to the present disclosure.

FIGS. 9A, 9B, and 9C are side views of several variations of another embodiment of a portion of an electrophotographic printing system including a substrate pre-heating heat transfer member including an optical member such as a mirror, lens, or prism, respectively, and optical heat source, each disposed for minimal spacing from the marking nip according to the present disclosure.

FIGS. 10 and 11 are system and component side views, respectively, of a heat pipe heat transfer member according to an embodiment of the present disclosure.

### DETAILED DESCRIPTION

Initially, descriptions of well-known starting materials, processing techniques, components, equipment and other well-known details are merely summarized or are omitted so as not to unnecessarily obscure the details of the present disclosure. Thus, where details are otherwise well-known, we leave it to the application of the present disclosure to suggest or dictate choices relating to those details.

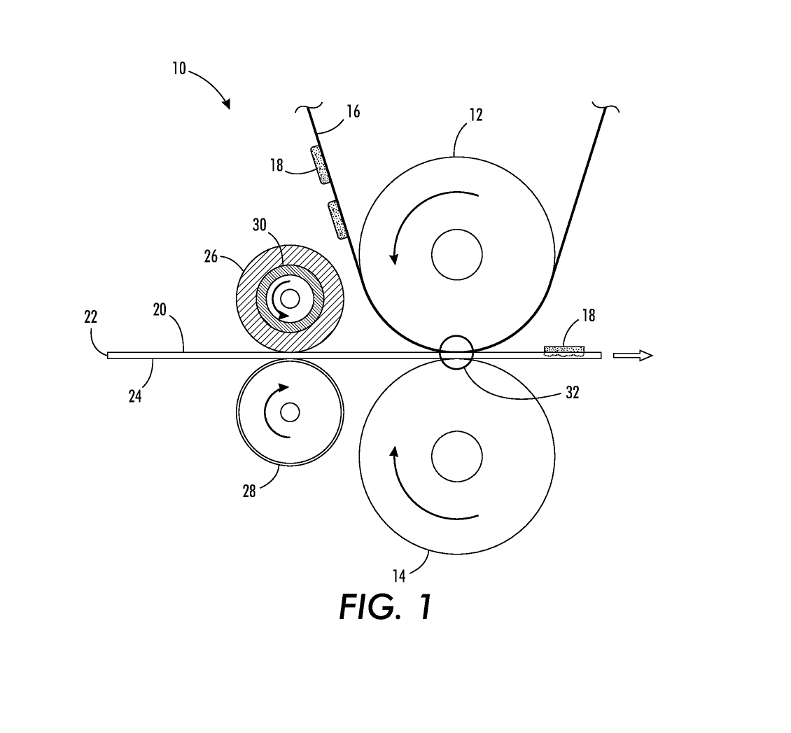

With reference to FIG. 1, there is shown therein a first embodiment of a portion of an electrophotographic printing system 10 according to the present disclosure. System 10 comprises a pair of pressure/guide drums 12, 14. Pressure/guide drum 12 carries a transfer surface web 16 for delivering marking material 18 to a first surface 20 of a substrate 22. Belt 16 may be a transfix belt, meaning that marking material 18 is transferred thereto from a photosensitive member (not shown) after development, or may itself be a photosensitive member. It will also be understood that while the embodiment of FIG. 1 shows marking material 18 carried by web 16, the teachings of this disclosure apply equally to systems in which marking material 18 is carried directly by drum 12, or when web 16 is replaced by other elements with similar functionality.

System 10 further comprises a pair of heat transfer members 26, 28. Heat transfer member 26 is located proximate surface 20 of substrate 22, which receives marking material 18, while heat transfer member 28 is located proximate surface 24 opposite surface 20. In one embodiment, heat transfer members 26, 28 are rollers, disposed so as to be in physical contact with substrate 22 as it passes through system 10. Heat transfer member 26 is provided with a heating mechanism 30, which heats at least the outer surface of heat transfer member 26. In one embodiment, heating mechanism 30 is a resistive heating element disposed within heat transfer member 26 such that when energized (i.e., a current is applied thereto) heating mechanism 30 provides radiant heat energy to the surface of heat transfer member 26. In other embodiments, heating mechanism 30 may be located external to heat transfer member 26, and may be a radiant filament heater, hot air heater or, in fact, any form of electrical, electromechanical or electrochemical heater which can controllably heat the surface of heat transfer member 26. Heat transfer member 28 will typically not be associated with a separate heating mechanism, and its surface generally will be at ambient temperature during operation.

In operation, as substrate 22 passes between heat transfer members 26, 28 surface 20 of substrate 22 is heated. As discussed further below, in order to minimize power consumption substrate 22 is heated only enough that marking material applied to surface 20 may fuse therewith. Substrate 22 then exits heat transfer members 26, 28 and marking material 18 is applied to surface 20 at nip 32 when the surface of web 16 carrying the marking material is brought into physical contact (or close proximity) with surface 20.

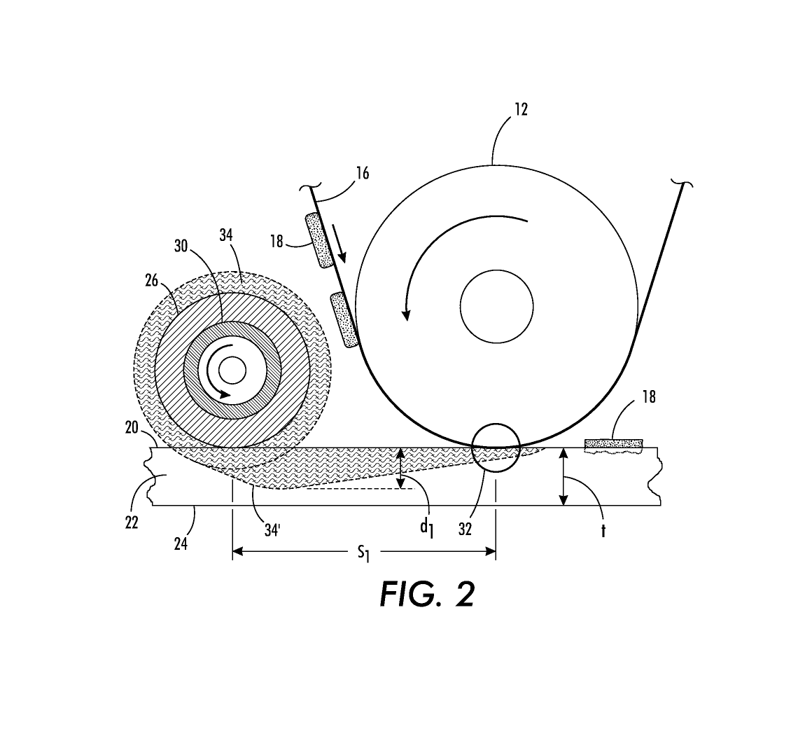

With reference to FIG. 2, the heating of substrate 22 is further explained. Fundamentally, the goal is to impart only the minimum amount of heat energy needed to facilitate fusing of the marking material 18 to substrate 22 (and fusing of marking material particles together at the point of fusing to substrate 22). To accomplish this, surface 20 passes by heat transfer member 26. Heat energy is thereby transferred into substrate 22 to create a bounded isotherm within substrate 22. The temperature of the surface of heat transfer member 26 is controlled such that the heat energy transferred into substrate 22 is just sufficient that, when taking into account the dissipation of heat energy in substrate 22 between its contact with the heat transfer member 26 and nip 32, the temperature of surface 20 at nip 32 permits fusing of the marking material into substrate 22. For example, the shaded region 34 illustrates the heat coming out of heat transfer member 26, including formation of the bounded isotherm 34′ within substrate 22, as shown in FIG. 2. Bounded isotherm 34′ is generally limited to a lateral section roughly between the region of contact of heat transfer member 26 with surface 20 and the region of contact of web 16 with surface 20. Furthermore, if t is the thickness of substrate 22, then the depth, d₁, of heated region 34 may be such that d₁<t, provided the temperature of substrate 22 in the region of nip 32 is sufficient to permit fusing. Since the temperature of substrate 22 at nip 32 is sufficient to facilitate fusing of marking material 18, any additional heat energy imparted to substrate 22 would be wasted.

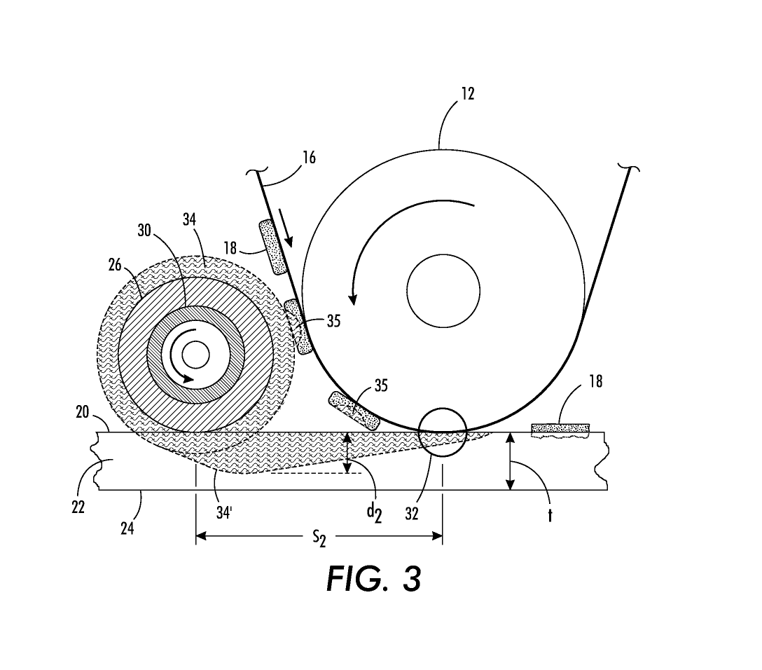

It will be appreciated from the above description that in order to reduce the energy consumed in pre-heating the substrate, it is desirable to locate heat transfer member 26 close to nip 32. That is, it is desirable to minimize the distance S₁ between the region of contact of heat transfer member 26 with surface 20 and the region of contact of web 16 with surface 20. This can beneficially lead to the condition illustrated in FIG. 3, in which the heat radiated by heat transfer member 26 pre-heats not just substrate 22, but also marking material 18 on web 16 as it passes close to heat transfer member 26. In certain embodiments this may be advantageous as less heat energy need be provided to substrate 22. In certain embodiments, this means that less of substrate 22 need be heated (i.e., d₂<d₁). This implies that in such embodiments a lower overall energy consumption may be possible.

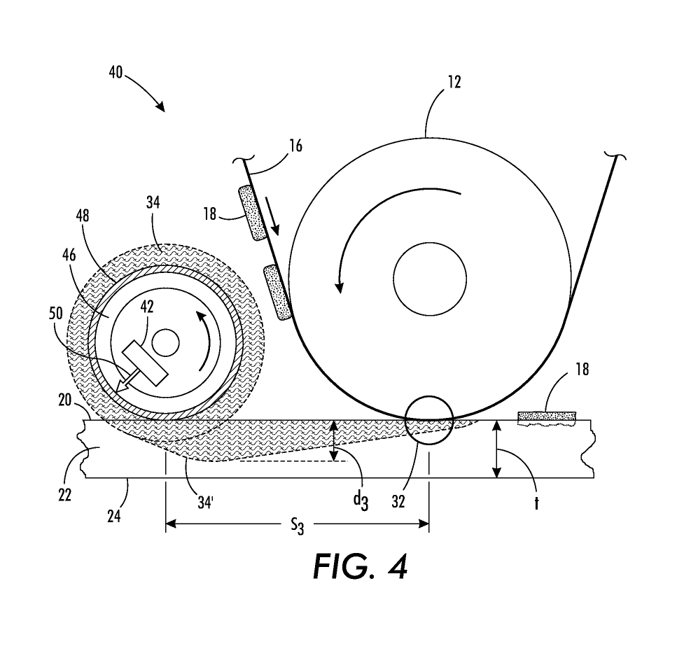

In the embodiments discussed above, the heating mechanism has been assumed to be electrical, electromechanical or electrochemical. The present disclosure is not so limited. With regard to FIG. 4, there is shown a system 40 in which the heating mechanism 42 is an optical heat source, such as a light emitting diode (LED) bar or array, solid-state laser bar or array, and so forth. An advantage of the optical source is the ability to rapidly cycle between on and off, thus rapidly heating the desired portions of the heat transfer member 44 when needed, and only when needed, thereby reducing device warm-up time and excess energy usage. Another advantage of the optical source is the ability to selectively heat certain portions, while not heating other portions, of heat transfer member 44, as will be discussed further below.

Heat transfer member 44 is comprised of a roller or cylindrical drum 46 that is optically transparent at the wavelength of emission of optical heating mechanism 42. A thermal absorption layer 48, of a material that is highly absorptive at the wavelength of light emitted by the optical source, is applied to roller 46, typically on the outer surface thereof. Roller or cylindrical drum 46 defines a cylindrical cavity in which optical heating mechanism 42 may be disposed. Optical energy (beam 50) from optical heating mechanism 42 is transmitted in a direction from a radially inward surface of drum 46 to a radially outward surface of drum 46 (i.e., radially outward through drum 46) and absorbed by layer 48, resulting in heat energy being propagated into region 34, 34′ as described above. An anti-reflective coating (not shown) on the inward surface of drum 46 may improve the absorption and/or the rate of absorption by layer 48.

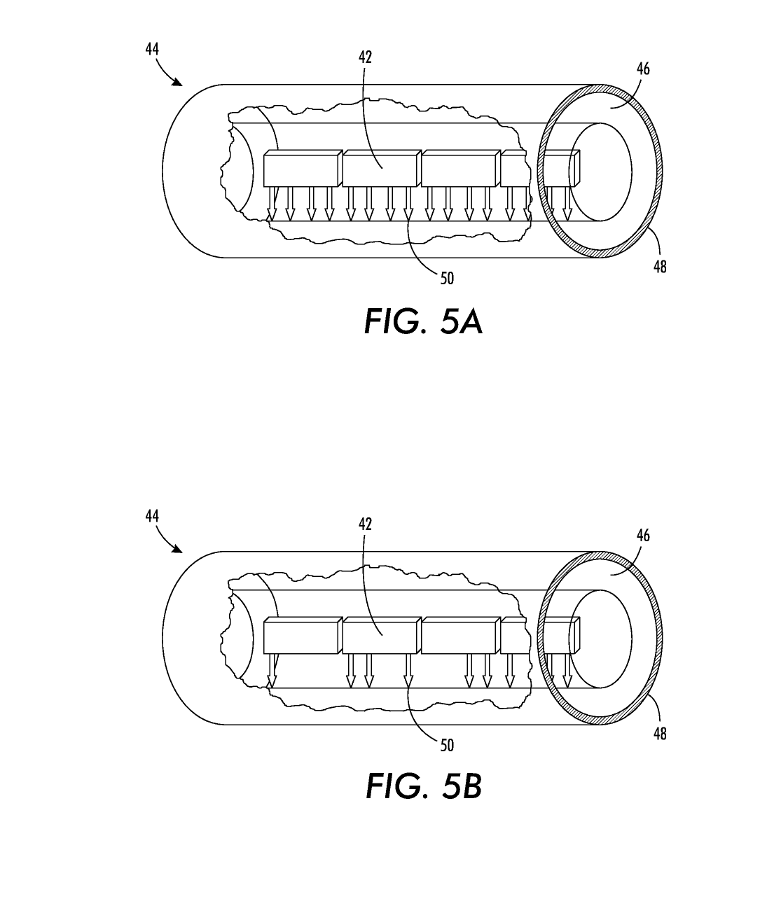

While optical heating mechanism 42 may be a single emitter device that emits a single beam as illustrated in FIG. 4, the optical heating mechanism may be a multiple emitter device capable of producing multiple optical beams generally parallel to beam 50 extending along the axial length of roller 46. This is illustrated in FIG. 5A, which illustrates 4 light emitting diode bars, although this number is arbitrary, and may be larger or smaller, and may be bars providing a one-dimensional row of beams or may be arrays providing two-dimensional arrays of beams, depending on the application of the present disclosure.

In certain embodiments, each emitter in the bars or arrays comprising optical heating mechanism 42 are operated together, as shown in FIG. 5A. In other embodiments, such as illustrated in FIG. 5B, the individual emitters in each bar or array are operated independently. Independent operation provides the desirable option that certain regions of substrate 22 may be heated when fusing is to occur in those regions, while regions not receiving marking material are not provided with heat energy. For example, at a given time t₁, certain emitters are operated while others are not. At a later time t₂, a different set of emitters may be operated. Software may be used to coordinate the operation of the emitters with the placement of marking material, so that where marking material is to be applied selected emitters are operated to heat the portions of the substrate that are to receive the marking material, on a line-by-line or pixel-by-pixel basis. Individually addressable optical sources permit selective heating of portions of the heat transfer member 44 (and ultimately substrate 22), reducing the energy consumed in pre-heating substrate 22.

While the embodiments described immediately above comprise optical heating mechanism 42 disposed within the core of heat transfer member 44, it is within the scope of the present disclosure to provide the optical heating element external to heat transfer member 44 (not shown). Single or multiple emitter laser diodes, lasers, raster optical scanners, and other devices and systems capable of producing multiple optical beams are examples of such external sources. In such a case, the output of the optical heating mechanism 42 is directed to the absorptive layer 48. Such an arrangement obviates the need for roller 46 to be optically transparent, as well as the need for the relatively large hollow region within roller 46 required to accommodate optical heating mechanism 42.

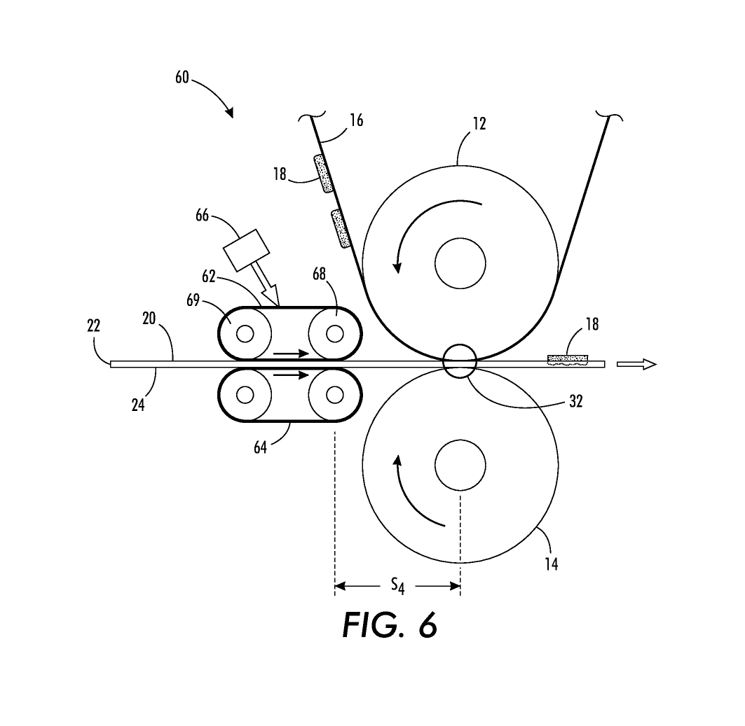

While the aforementioned embodiments have utilized a roller as a heat transfer member, other arrangements are contemplated herein. For example, FIG. 6 illustrates a system 60 which includes a pair of heating belts 62, 64. In the embodiment shown in FIG. 6, an optical heating mechanism 66 is employed, although an electrical, electromechanical or electrochemical heating mechanism may be substituted therefor in a manner previously described herein. Belt 64 is selected to have a surface that is absorptive at the wavelength of light emitted by optical heating mechanism 66. Furthermore, while the contact region between belt 62 and surface 20 is shown as linear, other arrangements are possible, such as contact over a large radius curve, which permits tensioning of belt 62 against surface 20. In general, the larger contact area and longer contact between belt 62 and surface 20 permits a more efficient transfer of heat energy from belt 62 to substrate 22. In addition, belt 62 is driven by and/or rides on rollers 68, 69, which generally will be of smaller diameter than the roller comprising the heat transfer member described above (i.e., member 26, FIG. 1). This permits positioning the source of heat energy closer to the nip (i.e., reducing the length s), further reducing the amount of energy required to heat substrate 22 to permit fusing.

In the embodiment described immediately above, the heating mechanism was optical, and disposed external to belt 62. However, it will be appreciated that heating mechanism 66 may be located between rollers 68, 69, and illuminate (heat) web 62 from the backside (i.e., from the inside). Furthermore, heat energy may be provided by an electrical, electromechanical or electrochemical heater, which may be located between rollers 68, 69 or within one or both of rollers 68, 69 (not shown).

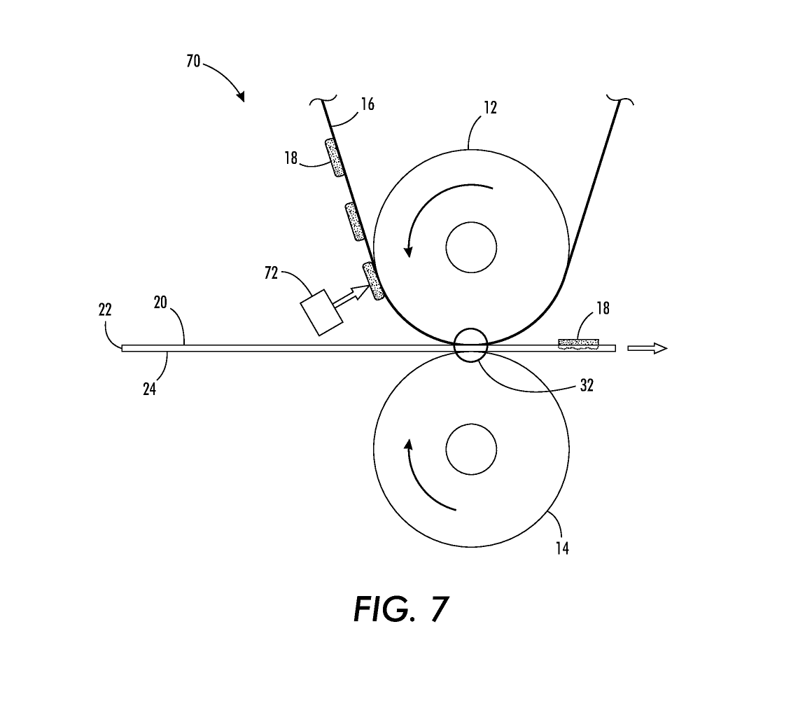

An alternative to heating a drum or belt is to heat the marking material such that fusing with the substrate and other marking material is facilitated. One embodiment for doing so has been described above with regard to FIG. 3. While the embodiment shown in FIG. 3 heats both the substrate and the marking material, embodiments that heat only the marking material are contemplated by the present disclosure. The heat transfer member 26 may be positioned such that it does not heat substrate 22, but heats only marking material 18 as described above. However, in another embodiment shown in FIG. 7, an embodiment 70 comprises an optical heating mechanism 72 capable of individually addressing marking material piles carried by web 16. Again, optical heating mechanism 72 may comprise a light emitting diode (LED) bar or array, solid-state laser bar or array, and so forth. Each emitter of optical heating mechanism 72 may be individually addressable so that light is only generated and made incident on marking material piles, not on the bare surface of web 16, in order that the total overall driving energy is minimized. This typically means that only a portion of the thickness of the marking material pile 18 on the web (or drum or plate) is heated, preferably a portion extending from the surface of the marking material which is applied to the substrate partway, but not all of the way, to the opposite surface in contact with the drum, web, plate, etc. And again, the light energy required is controlled so as to be only the minimum required to heat the marking material to facilitate fusing. It should be noted that heat transfer between marking material particles is poor because of the small effective contact area between particles. Thus, heat absorbed by ‘interfacial’ marking material particles is largely confined to those particles until pressure is applied which drives the sintering of marking material particles to each other and to the substrate.

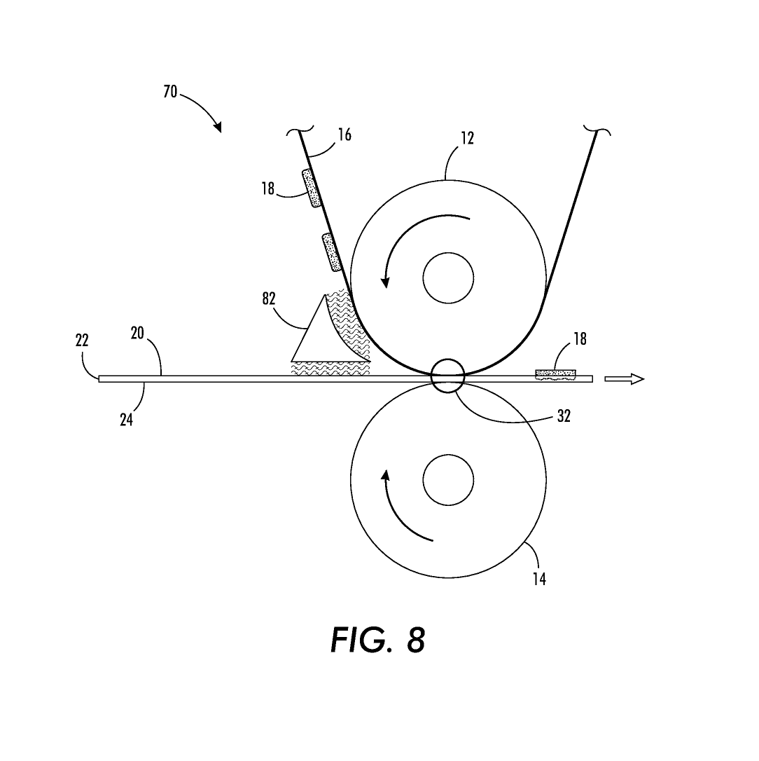

One aspect of minimizing the energy required to pre-heat either the substrate or the marking material for fusing is minimizing the time between heating either or both the substrate and marking material and the application of the marking material to the substrate at the marking (transfer) nip. The throughput rate of the system is fixed. This limits system design to minimizing the distance between heat application and nip. Thus, according to another embodiment of the present disclosure, the heat transfer member is neither a roller nor belt, but rather a member sized and shaped to be placed very close to the nip at which marking material is applied to the substrate. The precise cross-sectional shape of this member will vary from application to application, but one example 80 is illustrated in FIG. 8. In addition to elements previously described, system 80 comprises heat transfer member 82 with a substantially wedge-shaped or triangular cross-section for fitting very closely into the wedge-shaped region between the marking material side of web 16 as it wraps around pressure drum 12 and substrate surface 20. According to this embodiment, heat transfer member 82 may employ a heat source comprising a resistive heater or any other energy source such as an electrical, electromechanical or electrochemical heater.

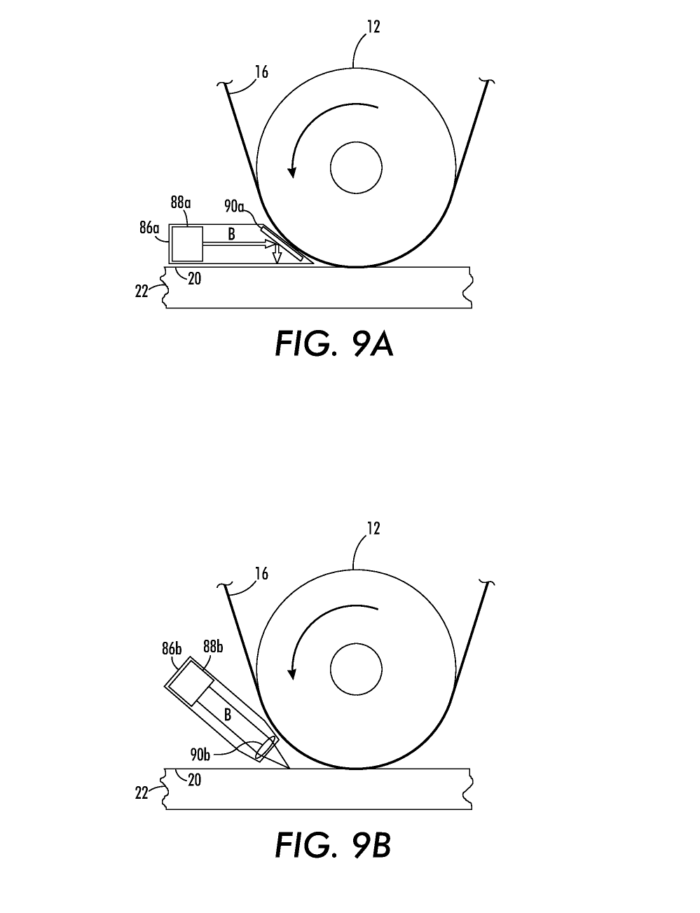

FIGS. 9A, 9B, and 9C illustrate several variations of another embodiment which facilitates providing heat energy to a substrate (or equivalently, the marking material) very close to the point at which marking material is applied thereto, thus enabling the preheating of the substrate (or equivalently, the marking material) with minimal unused heat energy. With reference to FIG. 9A, heat transfer member 86a comprises an optical heating mechanism 88a (LED bar, array, solid-state laser, etc.) which produces an optical beam B, which is directed to surface 20 (or to marking material 18, not shown) by an appropriately positioned and optical element 90a, which in the embodiment illustrated in FIG. 9A comprises a mirror. With reference to FIG. 9B, again, heat transfer member 86b comprises an optical heating mechanism 88b (LED bar, array, solid-state laser, etc.) which produces an optical beam B. In this variation, beam B is focused by lens 90b onto surface 20. Finally, with reference to FIG. 9C, heat transfer member 86c again comprises an optical heating mechanism 88c (LED bar, array, solid-state laser, etc.) which produces an optical beam B. In this variation, beam B is directed by prism 90c onto surface 20.

In each embodiment described herein, the optical heating element may comprise a monolithic, multiple emitter device, multiple discrete devices connected for simultaneous operation, or multiple discrete devices connected for independent operation, in each case either on a device-by-device basis or on an emitter-by-emitter basis.

Each of the embodiments of FIGS. 9A, 9B, and 9C are merely illustrative of the broader concept disclosed herein of intentionally designing and disposing a heat transfer member in close proximity to the point at which marking material is applied to a substrate so that only a minimum amount of heat energy is needed to facilitate or assist with marking material fusing at the substrate.

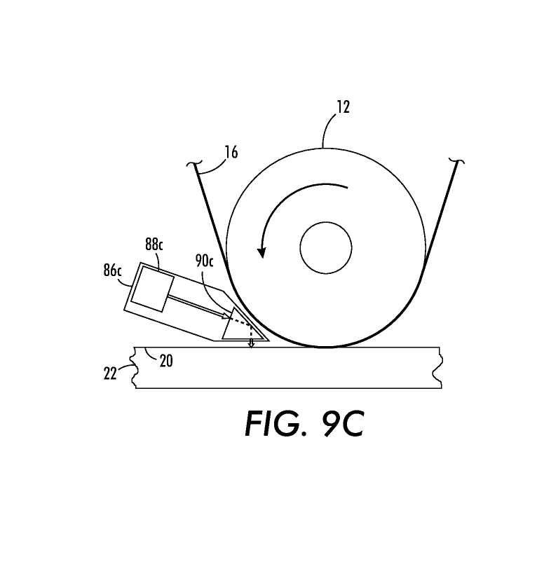

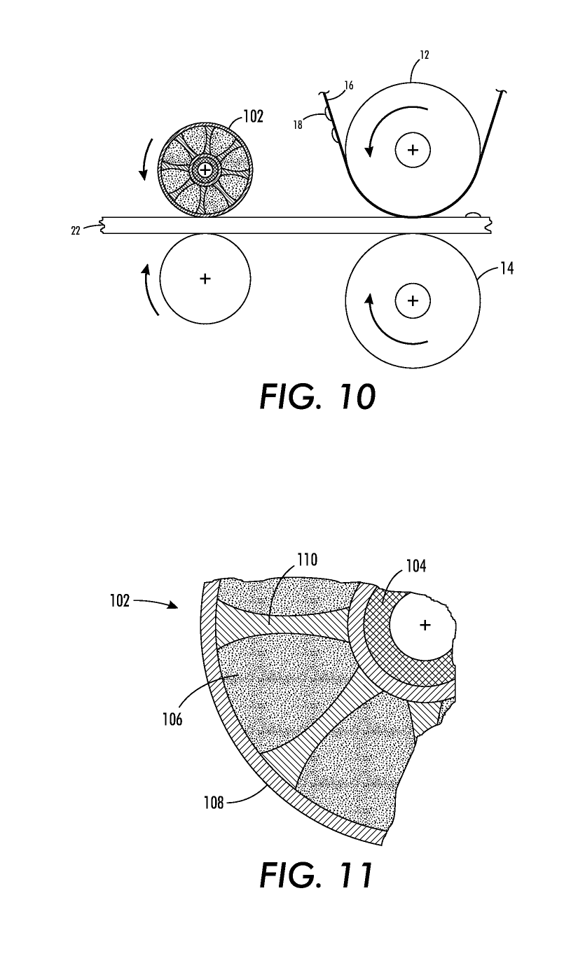

With reference to FIGS. 10 and 11, according to another embodiment 100 of the disclosure, heat transfer member 102 may include or be comprised of a heat pipe. Heat transfer member 102 itself comprises a heating mechanism 104, and at least one sealed, fluid-filled cavity 106, within a cylindrical housing 108 (e.g., double cylindrical walls with an enclosed annular cavity forming the heat pipe structure).

Cavity 106 maintains a controlled internal pressure corresponding to the vapor pressure of the enclosed fluid near the temperature at which effective heat transfer is desired for the particular application. Through constant phase change (vaporization) at a “hot” (i.e., heat source) portion of cavity 106 followed by transfer of the vaporized fluid to a “cold” (i.e., heat sink) portion of cavity 106, and its subsequent condensation near the heat sink portion, large amounts of heat can be quickly transferred due to the rapid phase change heat transfer effects. This heat transfer can be more efficient than a purely thermal conduction through solid walls (e.g., the wall of heat transfer member 26, FIG. 1). Typically, a wicking material 110 is also used to transfer the condensed (liquid) fluid back to the “hot” region within the heat pipe so as to continue the heat transfer cycle. Thus, heat generated (sourced) at (by) the heating mechanism 104 may be quickly and efficiently transferred to the outer surface of cylindrical housing 108 for subsequent coupling to substrate 22.

It will be appreciated that by minimizing the distance between the point of heat application to the substrate (or marking material) and the marking nip in the embodiments described above, the amount of time for heat energy to dissipate prior to the application of the marking material to the substrate surface is minimized, meaning that the total amount of energy required to drive the heat source can be kept to a minimum.

It should be understood that the description above merely illustrates exemplary embodiments with the scope of the disclosure, and that the limitations of the claims following define the boundaries of the present disclosure, up to and including those limitations. To further highlight this, the term “substantially” may occasionally be used herein in association with a description above or in a claim limitation (although consideration for variations and imperfections is not restricted to only those limitations used with that term). While as difficult to precisely define as the limitations of the present disclosure themselves, we intend that this term be interpreted as “to a large extent”, “as nearly as practicable”, “within technical limitations”, and the like.

Furthermore, while a plurality of preferred exemplary embodiments have been presented in the foregoing detailed description, it should be understood that a vast number of variations exist, and these preferred exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below.

Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

What is claimed is:

1. A method of affixing a marking material onto a substrate, comprising:
forming a latent image of marking material on a transfer surface;
heating at least one of the substrate and marking material such that said heating is limited to a portion of said at least one of said substrate and marking material which subsequently becomes the marking material-substrate interface, and only for a period of time such that said heating is sufficient to enable interfacial marking material fixing to the substrate;
bringing said substrate and said transfer surface into close physical proximity such that said marking material is transferred from said transfer surface to said substrate, the heating of at least one of the substrate and marking material thereby facilitating fixing of said marking material at said substrate;
such that said heating of said portion of said at least one of said substrate and marking material which subsequently becomes the marking material-substrate interface for only a minimum period of time required to facilitate fixing said marking material at said substrate, thereby conserving energy required for said fixing.

2. The method of claim 1, wherein said heating of at least one of the substrate and marking material is such that said heating is greater in a portion of said at least one of said substrate and marking material which subsequently becomes the marking material-substrate interface than outside of said portion, and further is accomplished by a heating method selected from the group consisting of: absorption, conduction, and convection.

3. The method of claim 2, wherein:
said heating is provided by activating a heating element associated with a heat transfer member disposed in close proximity to said transfer surface; and
bringing said substrate and said heat transfer member into close physical proximity such that said heat transfer member transfers heat energy to said substrate to create a region of elevated temperature in said substrate.

4. The method of claim 3, wherein:
said heat transfer member comprises an optical absorption layer on an outer surface thereof;
activating said heating element comprises activating an optical heat source such that at least a portion of its output is directed to said optical absorption layer and;
heating said heat transfer member comprises heating said optical absorption layer by said optical heat source, which transfers heat energy to said substrate to create a region of elevated temperature in said substrate.

5. The method of claim 4, wherein said optical heat source is a multiple emitter optical source, with each emitter being individually addressable, selected from the group consisting of: multiple emitter light emitting diode bars, multiple emitter light emitting diode arrays, multiple emitter solid-state laser bars, and multiple emitter solid-state laser arrays.

6. The method of claim 5, wherein each emitter of said multiple emitter optical source is addressed in coordination with the placement of marking material on said transfer surface such that appropriate emitters are operated to selectively heat portions of said substrate that are to receive said marking material, and not heat portions of said substrate that are not to receive said marking material.

7. The method of claim 4, wherein:
said optical heating element is a cylindrical drum which is substantially optically transparent at a wavelength of emission of said optical heat source;
said cylindrical drum defines a cylindrical cavity;
said optical heat source is disposed within said cylindrical cavity and oriented such that an optical beam output therefrom is directed in a direction from a radially inner surface of said cylindrical drum to a radially outer surface of said cylindrical drum; and
said thermal absorption layer is disposed on said radially outer surface of said cylindrical drum such that at least a portion of said optical beam output by said optical heat source is incident on said thermal absorption layer after passing through said cylindrical drum.

8. The method of claim 7, wherein further comprising:
bringing said marking material on said transfer surface and said heat transfer member into close physical proximity such that said absorption layer transfers heat energy to said marking material to a greater amount in a region of elevated temperature in said marking material than outside of said region of elevated temperature; and
bringing said substrate and said transfer surface into close physical proximity such that said marking material retains sufficient heat, at least in said region of elevated temperature, that the temperature in said region of elevated temperature of said marking material thereby further facilitates the fixing of said marking material.

9. The method of claim 8, wherein said region of elevated temperature in said marking material is of a thickness that is less than the overall thickness of said marking material.

10. The method of claim 3, wherein:
said heat transfer member is a belt having a surface on which said thermal absorption layer is disposed;
said heating element is directed to said surface of said belt; and
said surface of said belt and said substrate are brought into close physical proximity such that heat energy is transferred from said surface of said belt to said substrate.

11. The method of claim 3, wherein said heat transfer member has a substantially wedge-shaped cross-section so as to permit disposition thereof in very close proximity to a location at which said marking material is transferred from said transfer surface to said substrate to thereby further conserve energy required for said fixing.

12. The method of claim 3, wherein said heat transfer member comprises an optical heating element which emits an optical beam, and an optical element positioned in very close proximity to a location at which said marking material is transferred from said transfer surface to said substrate, said optical element directing said optical beam to a region of said substrate that is also in very close proximity to the location at which said marking material is transferred from said transfer surface to said substrate, to thereby further conserve energy required for said fixing.

13. The method of claim 12 wherein said optical element directs at least a portion of said beam to said substrate, and is selected from the group consisting of: a prism, a mirror, and a lens.

14. The method of claim 1, wherein said substrate is heated, said portion of said heated substrate comprises a region of elevated temperature in said substrate of a thickness that is less than the overall thickness of said substrate.

15. A method of affixing a marking material onto a substrate, comprising:
forming a latent image of marking material on a transfer surface;
activating a heating element, so as to heat at least a portion of a heat transfer member disposed in close physical proximity to said transfer surface;
bringing said marking material and said heat transfer member into close physical proximity such that said heat transfer member transfers heat energy to at least a portion of said marking material to create a region of elevated temperature in said marking material having a temperature above that of said marking material outside of said region of elevated temperature; and
bringing said substrate and said transfer surface into physical proximity such that said marking material is transferred from said transfer surface to said substrate, the elevated temperature in said marking material thereby facilitating fixing of said marking material;
the close proximity of said heat transfer member to said transfer surface permitting heating only that portion of the marking material, at a surface of said marking material which interfaces with said substrate, and only for a minimum period of time, required to facilitate fusing said marking material at said substrate, to thereby conserve energy required for said fusing.

16. The method of claim 15, wherein activating said heating element comprises heating by a heating method selected from the group consisting of: absorption, conduction, and convection.

17. The method of claim 15, wherein said heating element is a multiple emitter optical source selected from the group consisting of: multiple emitter light emitting diode bars, multiple emitter light emitting diode arrays, multiple emitter solid-state laser bars, and multiple emitter solid-state laser arrays.

18. The method of claim 17, wherein each said emitter of said multiple emitter optical sources is individually addressable.

19. The method of claim 18, wherein each emitter of said multiple emitter optical source is addressed in coordination the with placement of marking material on said transfer surface such that the appropriate emitters are operated to selectively heat portions of said substrate that are to receive said marking material, and not heat portions of said substrate that are not to receive said marking material.

20. The method of claim 15, wherein said region of elevated temperature in said marking material is of a thickness that is less than the overall thickness of said marking material.
